(19) United States
(12) Patent Application Publication
(10) Pub. No.: US 2014/0285646 A1
(43) Pub. Date: Sep. 25, 2014

(54) APPARATUS FOR RECOMMENDATION FOR BEST FITTING SHOE

(71) Applicant: Satwinder Kahlon, Austin, TX (US)

(72) Inventor: Satwinder Kahlon, Austin, TX (US)

(21) Appl. No.: 14/074,431

(22) Filed: Nov. 7, 2013

Related U.S. Application Data
(60) Provisional application No. 61/724,173, filed on Nov. 8, 2012.

(51) Int. Cl. A43D 1/02; H04N 13/02; H04N 5/225

(52) U.S. Cl. CPC A43D 1/025; H04N 5/2252; H04N 13/0275
USPC 348/77

(57) ABSTRACT

A system for providing a list of the best fitting shoes based on comparison of the users foot's measurements and that of the shoes. The measurements are taken from the 3 Dimensional (3D) model, using automated photogrammetry techniques. The 3D model is generated from the images captured by cameras inside the apparatus. The data captured is stored on remotely connected database. User preferences are also taken into consideration for the recommendation of the shoes.

### CROSS-REFERENCE TO RELATED APPLICATIONS

The present application relates to, is a continuation-in-part of, claims priority from and the benefit of U.S. provisional application Ser. No. 61/724,173, filed Nov. 8, 2012, by the same inventor and having the same title, the disclosure of which is incorporated herein by reference.

### FIELD OF THE INVENTION

The present invention relates to principles of photogrammetry, 3D scanning, and the matching of collected data, in context with the foot, and more particularly with determination of a list of best fitting shoes for the foot.

### BACKGROUND

In the past a number of patents have been issued related to apparatus of determining the shoe size. The commonly known foot size measurement device, called Brannock's device was disclosed in U.S. Pat. No. 1,725,334. This describes a mechanical device which can guide the user with the length of the foot and the width of the foot.

Berlin in U.S. Pat. No. 2, 975, 519 described the apparatus for determining the size of the shoe by directing a light source is towards an opaque plane containing a series of holes strategically placed so as to correspond to the longest and widest portions of an average foot of various sizes. A system of photo-voltaic cells to capture light from holes through which light passes, along with stepper relays, linkages and print wheels is used to print the foot size.

An apparatus using light source to cause an outline of a foot to be delineated upon a translucent is described by Gardner in U.S. Pat. No. 4,538,353. Light energy is directed from the panel through photo optic means to an electronic device containing means for inherently to an electronic device containing means for inherently discriminating impulses of energy into a distinct white/black status to produce an electronic duplicate of the foot outline. The electronic image is processed within the apparatus to determine foot measurement.

In U.S. Pat. No. 5,671,055, Whittlesey et al. describe the apparatus system and method for laser measurement of an object shape. The apparatus consists of a turntable, a laser camera, robotic control and a camera. The apparatus further reports the shoe size for the foot for which the laser based image was generated.

Another apparatus for measuring the shape of foot was described by Fujita et al. in U.S. Pat. No. 6,909,513 B1. This apparatus has a measuring head to measure the shape of an object at plurality of positions. The head takes measurements at the positions while moving along a guide rail.

### SUMMARY

Apparatus for creating a 3 Dimensional (3D) model from plurality of images captured by multiples cameras, and matching it to previously captured data for shoes, and recommending a shoe with likelihood of the best fitting shoe. The apparatus consists of a kiosk with two openings for placement of feet, left and right. Inside the kiosk, the feet or shoe rests on a glass plate. Computer system is integral part of the apparatus. The computer can take plurality of images of each of the foot, from all directions—left, right, front, back, top and bottom. The images are processed to create a 3D model of the image. Automated photogrammetry tools are used to take key measurements of the foot. Independently, similar dimensions were taken from shoe models from manufacturers. This shoe data is stored in a database on a separate remote server accessible to the computer system in the kiosk, via network. The person whose foot has been photographed can enter independent preferences for the footwear. The computer system matches the data from the 3D image measurements, with the preferences and against the shoe data from the database. A recommended list of matching shoes is presented to the person whose foot was photographed.

### BRIEF DESCRIPTION OF THE DRAWINGS

FIG. 1 is a frontal view of the apparatus in accordance with the present invention;

FIG. 2 is view of the foot placed on the glass plate inside the chamber;

FIG. 3 is a top view inside the chamber inside the apparatus;

FIG. 4 is a cut-out side view of the chamber;

FIG. 5 is a flow chart for operating the system;

FIG. 6 is a flow chart of match of the shoe.

### DETAILED DESCRIPTION

A significant percentage of the population has shoes that do not fit properly. Currently, the process of determination of the best fitting shoe is cumbersome as well as antiquated. This disclosure provides a system to recommend the best fitting shoe based on measurements provided by an apparatus, shoe data stored in a database and user preferences.

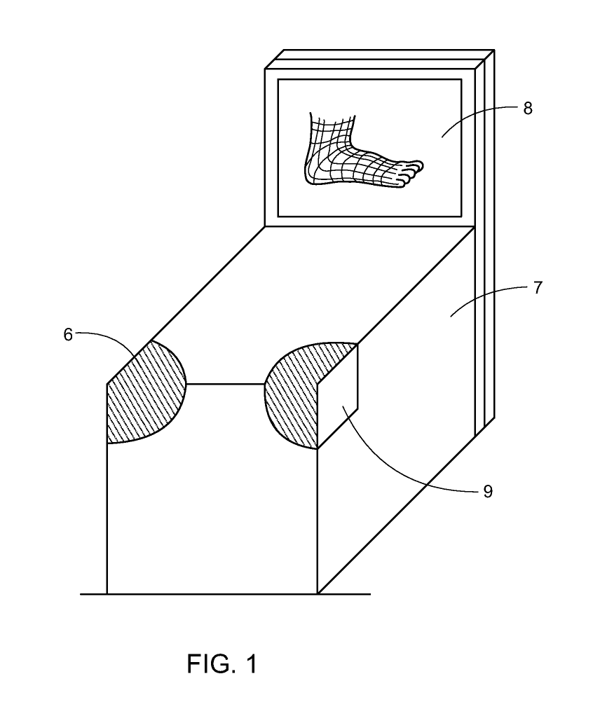

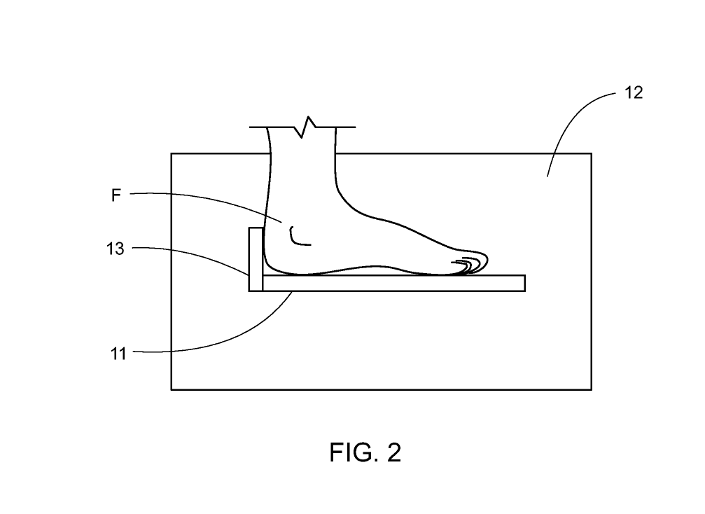

FIGS. 1 and 2 show a preferred exemplary embodiment of the apparatus of the subject invention. Both figures are described together. The unit consists of a kiosk (7), which has a pair of openings (6) for placement of the foot (F) or a shoe. Each opening is designed keeping in mind an ergonomic design, so it is convenient for the person whose shoe measurements are being taken. To allow cleaning and sanitization of the area inside the opening, a closable door (9) is provided.

Inside the opening (6) is a chamber (12). The chamber has a base of non-breakable glass, or other suitable transparent material, plate (11). The glass plate is where the flat part of the foot is placed. The glass plate is made up of strong material that resists breakage, as well as it does not reflect light. The length of the glass plate is 38 cm which is longer than the average length 26.3 cm plus the standard deviation of 1.2 cm. The width of the glass is 15 cm which is wider than the widest foot measurement. The glass plate roughly follows the outline of the longest and the widest foot. The backend of the glass plate joins a vertical contoured plastic material (13), providing the guideline for placement of the heel.

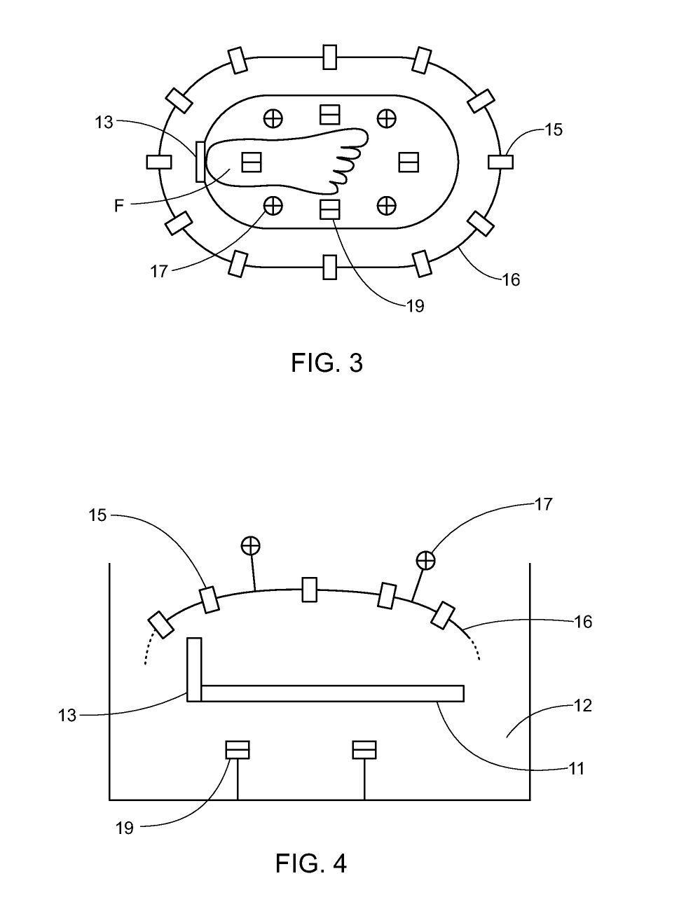

FIG. 3 is a top view inside the chamber inside the apparatus. FIG. 4 is a cut-out side view of the chamber. FIGS. 3 and 4 are described here. Around the glass plate is a railing (16) in all directions. The railing has mounting of small sized commercially available cameras. There are also cameras positioned above the foot (19), mounted off the same railing. And, there are cameras below the foot (19). The preferred number of cameras is 20, with 4 cameras on top of the foot, 4 below the foot, and remaining 12 that are on the side and front of the glass plate, where foot is positioned. The number of cameras taking pictures is adjustable via software.

Inside the kiosk is also a general purpose high performance computer and its related peripherals. To minimize the support issues, the computer is a fanless, and has Solid State Drive (SSD). The computer has wireless capability for connectivity to the Internet. All the cameras are connected via USB hub to the computer. There is a door on the back of the kiosk to access the computer. That door also has venting holes to keep the temperature inside the kiosk within comfortable limits. A keyboard and mouse can be connected to the computer.

The computer system is powered by standard 120V cord with standard electrical plug.

Also mounted in the kiosk is a touch screen display (8), which is connected via HDMI to the computer.

In addition to the kiosk, a central server serves as a repository (database) for measurements (data) collected from the scanning of the shoes and the foot.

At a time prior to scanning of any users foot, a large number of shoes have been scanned to collect and store data in the database. This data can also be present (if available) from the shoe manufacturer.

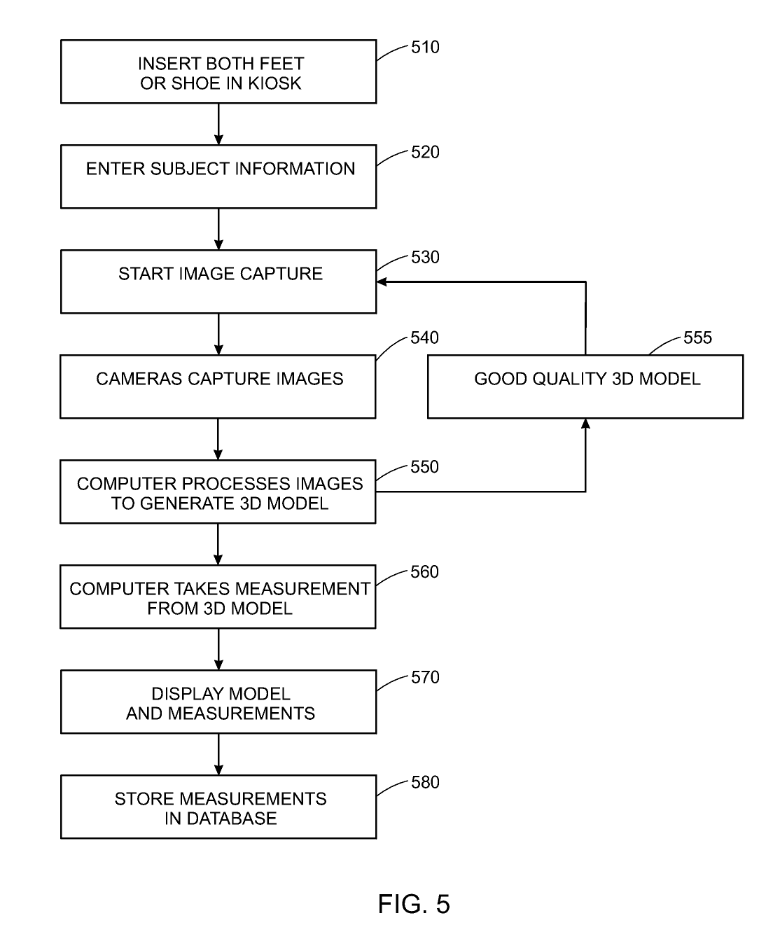

FIG. 5 is a flow chart for operating the kiosk. The flow of the process to determine the best shoe fitting will now be described. Using the touch screen and on-screen keyboard, the user logs in to the application 520. The authentication process is custom applications based, and also leverages one available from popular web sites such as Facebook, LinkedIn, Yahoo, and the like. Once the user has logged in, a welcome screen is presented, and user is asked to insert feet in the opening 510. Once the system detects via a camera that the foot is inside the chamber, the system prompts the user to begin scanning 530.

The method to scan a shoe is similar to that of foot except a pre-setup custom login id is associated with shoe measurements.

Once user has selected start of scanning, the software uses cameras to take images of the foot 540. These images are then processed to develop a 3D model of each foot 550. The quality of the 3D image is checked either automatically or visually 555. From the 3D model, the software calculates key measurements of the foot 560. These measurements include the following, but not limited to: length from mid-center part of the back of heel to the big toe, length from mid-center part of the back of heel to the small toe, maximum width, distance between big toe and small toe, height of the foot at toe level, height of the foot at shoe lace level and arch of the foot. These measurements are taken for both feet. This is to account for differences in the foot anatomy of people.

While the software is building the 3D model, the user is asked for preferences such as their last shoe brand, the color of the shoe, and brand preference 570. This set of preferences is easily customizable.

The user then saves the data. At that point in the process, the data from the kiosk, is saved onto the database 580. It is presented to the user the next time, the user signs in to the system.

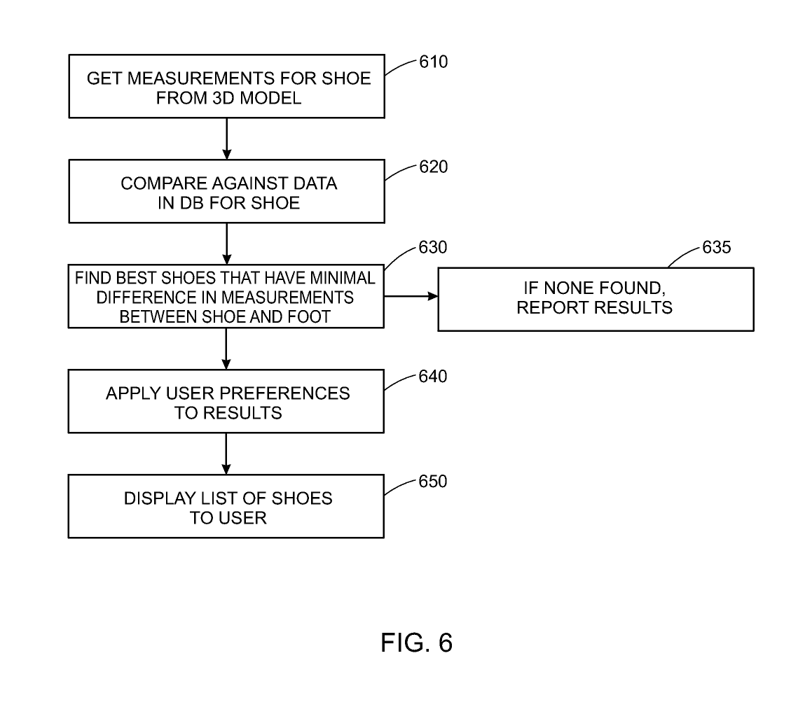

FIG. 6 is a flow chart of match of the shoe. The measurements obtained from the 3D model 610 are compared with that taken for the shoe 620. An adjustment is made for the thickness of the material of the shoe, as part of the preferences. Objective of match is to come up with a list of shoes in preference order that are matching on most attributes 630. The criterion used to match is in the following order: length from mid-center part of the back of heel to the big toe, length from mid-center part of the back of the heel to the small toe, maximum width, distance between big toe and small toe, height of the foot at toe level, height of the foot at shoe lace level and arch of the foot. If the measurement of the shoe is lower than corresponding measurement of the foot, foot is considered to be tight. On the contrary, if the measurement of the shoe is higher than the corresponding measurement of the foot, foot is considered to be loose. A list is developed of shoes that are not loose or tight. The user preferences 640 are then matched against the list to determine the most fitting shoe for the user. The list is presented to the user in the display 650.

Specific exemplary embodiments of the present system for the measurement of several characteristics of the foot provide without limitation a kiosk, a chamber with a closable door, a transparent plate inside the chamber where the foot is placed for measurement, mountings and positional placement of multiple cameras in a variety of predetermined positions in the chamber directed toward the foot location to capture images of the foot such that a 3D model of the foot is generated from the images captured by the cameras, a database of shoes which includes the size and other measurements of each shoe, and a recommendation generator that generates recommendations of shoes based on relating the 3D model of the foot to the database of shoes.

Additional specific embodiments of the system provide without limitation a railing for positioning of cameras at predetermined locations. For example, four above the foot, four below the transparent plate, and twelve spread out around the transparent plate at a height selected for generating a 3D model of the foot. A touchscreen display to collect data from a user, to initiate the process to start capturing of images and to display the results is provided in specific embodiments.

Specific embodiments of the system provide without limitation a computer that executes instructions stored in a non-transitory media to capture images, process the captured images into a 3D model, and take measurements of the foot or shoe. Such a computer preferably provides Universal Serial Bus (USB) hubs to attach the cameras to the computer. Further preferred embodiments of the computer have wireless capability to provide network connectivity, for purpose of storing measurements in a remotely connected database.

A preferred embodiment of the chamber provides a vertical, contoured, retainer piece to act as a guide for placement of the heel of the foot. Ergonomic design of the kiosk for comfortable placement of the foot for young or old user is also preferred.

Methods for determining the best fitting shoe are contemplated by the present disclosure. An exemplary embodiment of such a method includes without limitation providing a kiosk having a power source and a foot measurement chamber; inserting the left and/or right foot into the measurement chamber; photographing the foot from enough positions to generate a 3 dimensional model of the foot; providing a database of shoes which includes the size and other measurements of each shoe; matching of the foot measurements against those of the shoes in the database; taking user shoe preferences; determining the best matching shoes from the database; and providing recommendations of shoes to the user.

Certain specific exemplary alternative embodiments of the methods further include without limitation the steps of providing a user login to establish a session for capturing shoe or foot information and storage of data into the database, in some embodiments the user can initiate the image capture process; taking measurements of the foot from the 3D model of the foot; and submitting the data of the shoe measurements for storage in a database to a computer connected to the system. Similarly, measurements can be taken of a selected shoe and the data stored in the database. Methods also include without limitation collecting user preferences and applying the preferences to formulate shoe recommendations; comparing the data of the foot and shoe to determine the recommended shoes, and generating a list of recommended shoes. The list of recommended shoes is ordered in descending fashion from the most highly recommended to the least recommended in certain exemplary embodiments.

What is claimed is:

1. A kiosk for the measurement of a plurality of characteristics of the foot, to compare the plurality of characteristics against a database of shoes, and to determine the best match between a shoe in the database and the measurement of the plurality of foot characteristics, the kiosk comprising:
(a) a chamber with a closable door;
(b) a transparent plate inside the chamber where the foot is placed for measurement;
(c) a plurality of cameras in a variety of predetermined positions in the chamber directed toward the foot location to capture images of the foot such that a 3D model of the foot is generated from the images captured by the cameras; and
(d) a database of shoes which includes the size and other measurements of each shoe, and a recommendation generator that generates recommendations of shoes based on relating the 3D model of the foot to the database of shoes.

2. The foot measurement kiosk of claim 1, the kiosk further comprising a railing around the transparent plate for positioning of two or more of the plurality of cameras at predetermined locations.

3. The foot measurement kiosk of claim 1, the kiosk further comprising a computer, in electronic communication with the plurality of cameras and the database, that executes instructions stored in a non-transitory media to capture images, process the captured images into a 3D model, and take measurements of a foot.

4. The foot measurement kiosk of claim 3, wherein the computer further comprises a touchscreen display to collect data from a user, to initiate the kiosk to start capturing of images with the plurality of cameras, and to display information.

5. The foot measurement kiosk of claim 4, wherein the computer further comprises wireless connectivity to the database.

6. The foot measurement kiosk of claim 1, the kiosk further comprising a contoured, retainer member to act as a guide for placement of the heel of a foot.

7. A kiosk for the measurement of a plurality of characteristics of the foot, to compare the plurality of characteristics against a database of shoes, and to determine the best match between a shoe in the database and the measurement of the plurality of foot characteristics, the kiosk comprising:
(a) a chamber with a closable door;
(b) a transparent plate inside the chamber where the foot is placed for measurement;
(c) a plurality of cameras in a variety of predetermined positions in the chamber directed toward the foot location to capture images of the foot such that a 3D model of the foot is generated from the images captured by the cameras;
(d) a database of shoes which includes the size and other measurements of each shoe, and a recommendation generator that generates recommendations of shoes based on relating the 3D model of the foot to the database of shoes
(e) a railing around the transparent plate for positioning of two or more of the plurality of cameras at predetermined locations;
(f) a contoured, retainer member to act as a guide for placement of the heel of a foot;
(g) a computer, in electronic communication with the plurality of cameras and the database, that executes instructions stored in a non-transitory media to capture images, process the captured images into a 3D model, and take measurements of a foot;
(h) a touchscreen display in electronic communication with the computer to collect data from a user, to initiate the kiosk to start capturing of images with the plurality of cameras, and to display information
(i) The foot measurement kiosk of claim 4, wherein the computer further comprises wireless connectivity to the database.

8. The foot measurement kiosk of claim 7, the computer further comprising. wireless connectivity to the database.

9. The foot measurement kiosk of claim 7, wherein the electronic communication of the computer with the plurality of cameras is wireless.
